(19) United States
(12) Patent Application Publication
(10) Pub. No.: US 2020/0044494 A1
(43) Pub. Date: Feb. 6, 2020

(54) HIGH-MAGNETIC-FLUX DISCRETE STATOR ELECTRICAL MACHINE

(71) Applicant: StarRotor Corporation, College Station, TX (US)

(72) Inventors: Michael J Van Steenburg, Garden Ridge, TX (US); Mark T Holtzapple, College Station, TX (US)

(73) Assignee: StarRotor Corporation

(21) Appl. No.: 16/495,824

(22) PCT Filed: Mar. 20, 2018
(86) PCT No.: PCT/US18/23292

§ 371 Date: Sep. 19, 2019

Related U.S. Application Data
(60) Provisional application No. 62/474,025, filed on Mar. 20, 2017.

(51) Int. Cl. H02K 1/14; H02K 3/42; H02K 9/20; H02K 41/03; H02K 21/14

(52) U.S. Cl. CPC H02K 1/145; H02K 3/42; H02K 2201/12; H02K 41/031; H02K 21/145; H02K 9/20

(57) ABSTRACT

Electrical machines such as electromagnetic devices rely on the magnetic flux to create the forces required to move the component that transfers the work output of the device. Embodiment of the disclosure achieve this through a unique stator pole to rotor/actuator pole configuration that maximizes the magnetic flux flow across the air gap(s). This is achieved by tilting the air gap in more than one plane with respect to the rotation plane of the rotor.

### CROSS-REFERENCE TO RELATED APPLICATIONS

This application is a United States national stage filing of PCT Application No. PCT/US18/23292 filed on Mar. 20, 2018, which claims priority to U.S. Provisional Application No. 62/474,025 filed on Mar. 20, 2017. This application claims the benefit and priority of U.S. Provisional Application No. 62/474,025

### TECHNICAL FIELD

This invention relates to electric machines and, more particularly, to electromagnetic devices such as rotary motors and generators, and linear actuators and solenoids.

### BACKGROUND

In generators, input energy is mechanical work and output energy is electrical work. In motors, input energy is electrical work and output energy is mechanical work. Most electrical machines are reversible and can function as either motors or generators.

In motors, electrical energy input imparts motion to one or more components of the machine, such as rotors, solenoids, or actuators. Solenoids and actuators typically move linearly whereas rotors rotate.

Many modern applications of electric motors require high power density. For example, modern automobiles increasingly use electrical energy in either hybrid vehicles or battery vehicles. Automobile performance is significantly enhanced with lightweight electric motors mounted directly on the automobile body or its wheels. At a given motor speed, shigh power density requires high torque density.

### SUMMARY OF THE DISCLOSURE

The present disclosure relates to electrical machines and more specifically to electrical machines that do work on moving objects. The present disclosure provide numerous unique features that maximize the magnetic flux density in a magnetic circuit for electromagnetic motors, generators, solenoids, and actuators.

The rotor moves through the stator magnetic circuit at an angle; thus, the surface area between the rotor and stator is increased, which reduces the reluctance and increases the magnetic flux in the circuit. The result is greater magnetic force between the stator and rotor pole, and hence greater torque.

If the air gaps that the rotor passes through are angled with respect to the major magnetic flux path through the stator and rotor pole loop, then the surface area of the air gap will be maximized, as a function of the sine of the angle between the major magnetic flux path and the direction of rotation of the rotor pole, and result in a greater magnetic force between the stator and rotor pole.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

### BRIEF DESCRIPTION OF THE DRAWINGS

For a more complete understanding of this disclosure and its features, reference is now made to the following description, taken in conjunction with the accompanying drawings and tables, in which:

FIG. 1 shows a magnetic circuit consisting laminated ferromagnetic material separated by thin insulating layers that prevent energy-robbing eddy currents;

FIG. 2 show an magnetic circuit identical to FIG. 1, except the linear actuator is also comprised of laminated ferromagnetic material;

FIG. 3 is identical to FIG. 2, except that the linear actuator is drawn into the magnetic circuit at an increased angle (ϕ>90°);

FIG. 4 is identical to FIG. 2, except the side of the actuator is at an increased angle (ω>90°);

FIG. 5 is identical to FIG. 2, except the side of the actuator is “rippled”;

FIG. 6 is a cross-sectional illustration of a single transverse-flux stator and rotor pole magnetic flux loop showing the air gaps that the rotor pole passes through around an axis that is horizontally located in the plane of the page;

FIG. 7 is a cross-sectional illustration of a single transverse-flux stator and rotor pole magnetic flux loop showing the air gaps that are angled in one direction with respect to the magnetic flux path through the stator and rotor poles;

FIG. 8 is a cross-sectional illustration of an alternative embodiment of FIG. 7, wherein the stator and rotor pole are at an angle compared to FIGS. 6 and 7 while the air gaps are also angled with respect to the magnetic flux path;

FIG. 9 is an illustration of an alternative embodiment of FIG. 8, wherein the air gaps are angled in two different directions with respect to the magnetic flux loop of the stator and rotor pole;

FIG. 10 is an illustration of another view of the embodiment shown in FIG. 9;

FIG. 11 is a cross-sectional illustration of a radial-flux electrical machine;

FIG. 12 is an illustration of an axial-flux electrical machine;

FIG. 13 is an illustration of a transverse-flux electrical machine; and

FIG. 14 is an illustration of an electrical machine that improves upon the designs described in U.S. Pat. No. 7,663,283.

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

### Definitions

The following provide definitions for general guidance concerning the present disclosure. These definitions should in no way be used to limit the scope of the invention.

Magnetic circuit—The magnetic circuit is a closed loop of ferromagnetic material. The magnetic circuit is analogous to a closed loop of pipe.

Copper coil—The copper coil wraps around the magnetic circuit. In principal, any electrical conductor could be used; however, according to particular embodiments of the disclosure copper is the most common material. A generic term for copper coil is “electric phase coil.” When electricity flow through the copper coil, it creates magnetism inside the magnetic circuit. The copper coil is analogous to a pump in a closed-loop pipe. Although a copper coil may be used to refer to certain embodiments, other material may also be used while still availing from the teachings of this disclosure.

Magnetic field intensity (H)—The magnetic field strength increases with the number of windings and the current in the copper coil. The magnetic field intensity is analogous to pressure produced by a pump.

Magnetic flux—The magnetic flux is an extensive quantity that describes the total strength of magnetism and is measured in webers (Wb). The magnetic flux is analogous to the total mass flow in the closed pipe measured in kg/s.

Magnetic flux density (B)—The magnetic flux density is an intensive quantity that describes the strength of the magnetism per cross-sectional area of the magnetic circuit and is measured in webers per square meter (Wb/m2) or tesla (T). The magnetic flux density is analogous to the mass flux (i.e., flow per cross-sectional area of pipe) measured in kg/(m2·s).

Magnetic saturation—As the magnetic field intensity H increases, the magnetic flux density B increases to a limiting value that depends upon the properties of the ferromagnetic material. The phenomenon of magnetic saturation is analogous to a closed loop of pipe filled with a porous material, such as sand or gravel. Even at high pump pressure differences, friction limits the amount of fluid flow through the porous material. The flow characteristics will depend on the properties of the porous material. Small-diameter porous material (e.g., sand) will have a small mass flux because of the high friction whereas large-diameter porous material (e.g., gravel) will have a large mass flux because of the reduced friction.

### Contextual Overview

In generators, input energy is mechanical work and output energy is electrical work. In motors, input energy is electrical work and output energy is mechanical work. Most electrical machines are reversible and can function as either motors or generators. The following discussion focuses on electric motors; however, it is understood that the machines may be reversed and function as electric generators.

In motors, electrical energy input imparts motion to one or more components of the machine, such as rotors, solenoids, or actuators. Solenoids and actuators typically move linearly whereas rotors rotate. The following discussion focuses on rotary motors.

In rotary motors, the magnetic flux density generated by the stator(s) produces a resultant force that converts electrical work into mechanical work. The most common classes of rotary motors follow: (1) induction, (2) permanent magnet, and (3) reluctance. Common subclasses of motors include the following: (1a) AC induction, (2a) brushed DC permanent magnet, (2b) brushless DC permanent magnet, (3a) switched reluctance, and (3b) synchronous reluctance. Further delineation of rotary motors is achieved by referencing the direction of the magnetic flux path: (1) radial, (2) axial, and (3) transverse. Radial flux is the most common.

AC induction motors contain coils in both the stator and rotor. The coils in the stator produce magnetic fields that oscillate at the same frequency as the AC current. The rotor rotational frequency is slightly less than the frequency of the AC current, so-called “slip.” As a rotor coil slips past the stator magnetic fields, the dynamic magnetic field in the rotor coil induces a current. The resulting induced current generates its own magnetic field that opposes the applied field from the stator, and hence generates torque. The greater the slippage, the greater the torque, so such motors are self-regulating and hence very simple. Induction motors are not a topic of this patent and hence are not discussed further. The remainder of the discussion focuses on permanent magnet and reluctance motors.

Commonly, the ferromagnetic stator core of the permanent magnet or reluctance electric motors is a single component comprised of stacked-together individual insulated laminations that contain all of the active magnetic poles. The stator core is wrapped with copper coil(s) that are energized by an electrical current and voltage to generate a magnetic flux density within the stator core. The stator core plus the copper coil(s) is collectively described as the “stator.”

Typically, the rotor is comprised of separate ferromagnetic or permanent magnet components. In the absence of the rotor, the stator magnetic circuit is open and cannot sustain magnetic flux density. At particular angular positions, the rotor interacts with the stator magnetic circuit and completes it. When the rotor is fully misaligned with the stator, the magnetic flux density through the magnetic circuit is zero (i.e., zero energy in the magnetic circuit). When the rotor is fully aligned with the stator, the magnetic flux density through the magnetic circuit is maximum (i.e., maximum energy in the magnetic circuit). As the rotor rotates from fully misaligned to fully aligned, the magnetic flux density through the magnetic circuit increases allowing the energy of the magnetic circuit to increase from zero to maximum. By definition, energy is a force exerted over a distance. As the energy of the electric circuit increases, a force is generated on the rotor. The force is generated at a radius from the center of rotation, thus producing torque that acts on the rotor. In summary, as the rotor rotates and completes the magnetic circuit of the stator, torque acts on the rotor thus producing shaft power.

Many modern applications of electric motors require high power density. For example, modern automobiles increasingly use electrical energy in either hybrid vehicles or battery vehicles. Automobile performance is significantly enhanced with lightweight electric motors mounted directly on the automobile body or its wheels. At a given motor speed, high power density requires high torque density.

In an electric motor, high torque is achieved via the following methods:
Increase the number of poles—The torque produced in a single magnetic circuit is multiplied by the number of circuits along the periphery of the motor. Increasing the number of poles directly increases the torque.
Increase the magnetic flux—In the magnetic circuit, stronger magnetic flux results in greater maximum energy and hence greater torque.

In the magnetic circuit, the maximum magnetic flux is determined by the following factors:
Increase magnetic field intensity—Magnetic field intensity is the product of current and number of windings. The designer of electric motors selects the smallest wire gauge that can handle the current without overheating, and thus pack as many coils into a given volume as possible. To increase the amount of copper wire in the volume, some designers will select wire with a square cross section that packs more tightly than wire with a round cross section.
Select high permeability materials—As the magnetic field intensity increases, the ferromagnetic core saturates and can no longer accommodate a greater magnetic flux density. Selecting materials that saturate with a high magnetic flux density increases the maximum energy in the magnetic circuit, and hence the torque.
Minimize air gaps—For a given magnetic field intensity, in ferromagnetic materials the magnetic flux density is large. In contrast, for the same magnetic field intensity, in air the magnetic flux density is small. Thus, in a magnetic circuit, the presence of an air gap between the rotor and stator creates “reluctance,” i.e., the magnetic analogy to resistance in electrical circuits. Designers of electric motors minimize air gaps based on manufacturability limits and thermal expansion considerations.
Increase rotor/stator contact area—The reluctance of an air gap can be reduced by enlarging the cross-sectional contact area between the rotor and stator. This is analogous to adding parallel resistors to reduce the overall resistance of an electric circuit, which effectively increases the cross-sectional area through which electrons can flow.

This latter point is a key feature for certain embodiments described herein.

Motor design considerations related to the rotor/stator air gap parameters of certain embodiment of the disclosure:
1. Iron losses largely depend upon air gap flux density. Low iron losses enable lower operating temperatures and higher efficiency for electric motors.
2. Higher flux density in the air gap reduces machine size.
3. Higher flux density in the air gap reduces motor cost.
4. Maximizing the surface area between the stator and rotor poles maximizes magnetic flux transmission, which minimizes the volume of materials required.
5. Higher flux density in the air gap increases the overload capacity of the motor.
6. The greater the air gap surface area, the higher the torque capable from the electric motor.
7. The torque-per-unit-rotor volume (TRV) is a measure on the effectiveness of an electric motor and can help determine how “good” an electric motor is. The TRV is related to the tangential stress by the equation TRV=2σ^{mean} where σ^{mean} is the shear stress in the air gap between the rotor and stator (in N/m²).
8. The greater the air gap pole surface area the higher the electric loading allowable in the motor windings.
9. Rotor size is determined by the air gap surface area and a larger air gap surface area enables a smaller rotor size and hence a smaller motor size.
10. The increased surface area at the rotor/stator interface concentrates the magnetic flux density. This allows the use of low-cost ferrite magnets to achieve motor efficiency and performance that equals or exceeds much more expensive motors that use rare-earth magnets.

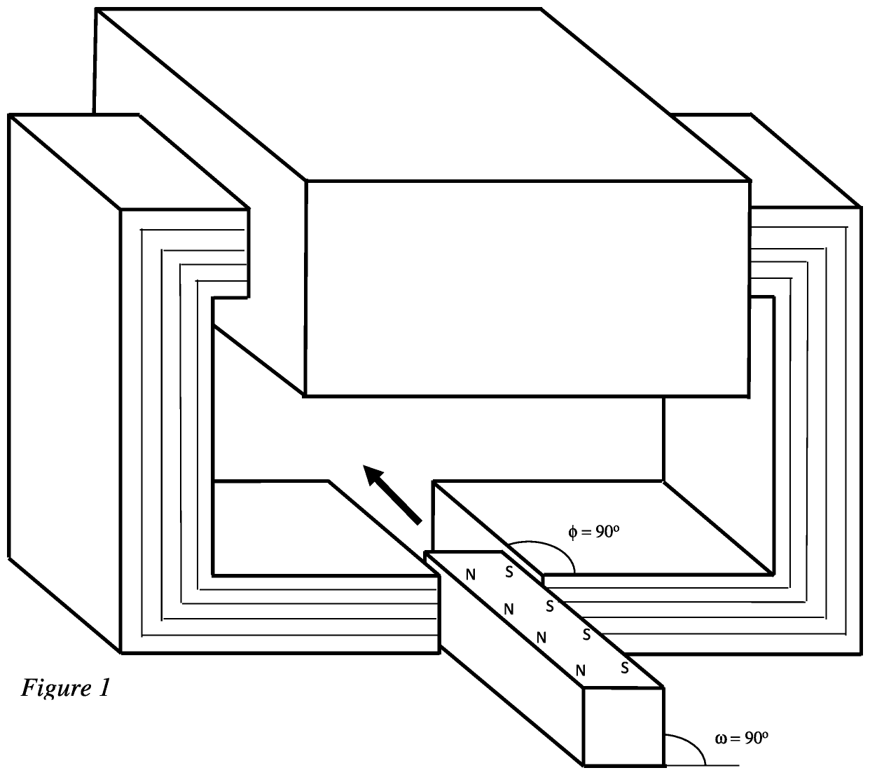

FIG. 1 shows a magnetic circuit with a laminated ferromagnetic material separated by thin insulating layers that prevent energy-robbing eddy currents. The top of the magnetic circuit has a copper coil that provides magnetic field intensity that generates magnetic flux. At the bottom, the linear actuator completes the magnetic circuit by moving in the direction shown by the arrow. In this case, the linear actuator is a permanent magnet with poles that align with the polarity of the magnetic field in the magnetic circuit, which draws the linear actuator into the magnetic circuit. When the current flows in the opposite direction through the copper coil, the magnetic field will switch polarity and eject the linear actuator from the magnetic circuit. Although this drawing shows a single linear actuator, the same concept can be applied to rotating equipment in which the permanent magnet is affixed to a rotor and rotates through the stationary magnetic circuit.

The magnetic flux density may not be uniform everywhere in the magnetic circuit and may be concentrated in particular regions. Regions with low magnetic flux density can employ inexpensive, low-saturation materials (e.g., silicon iron, 1.8 tesla). Regions with high magnetic flux density can employ more expensive, high-saturation materials (e.g., Supermendur, 2.2 tesla). In cases where rapid switching is required, amorphous alloys (e.g., METGLAS, 1.6 tesla) may be employed. The need for laminations can be eliminated by using isotropic composite cores being developed by Persimmon Technologies Corp. (Wakefield, Mass.).

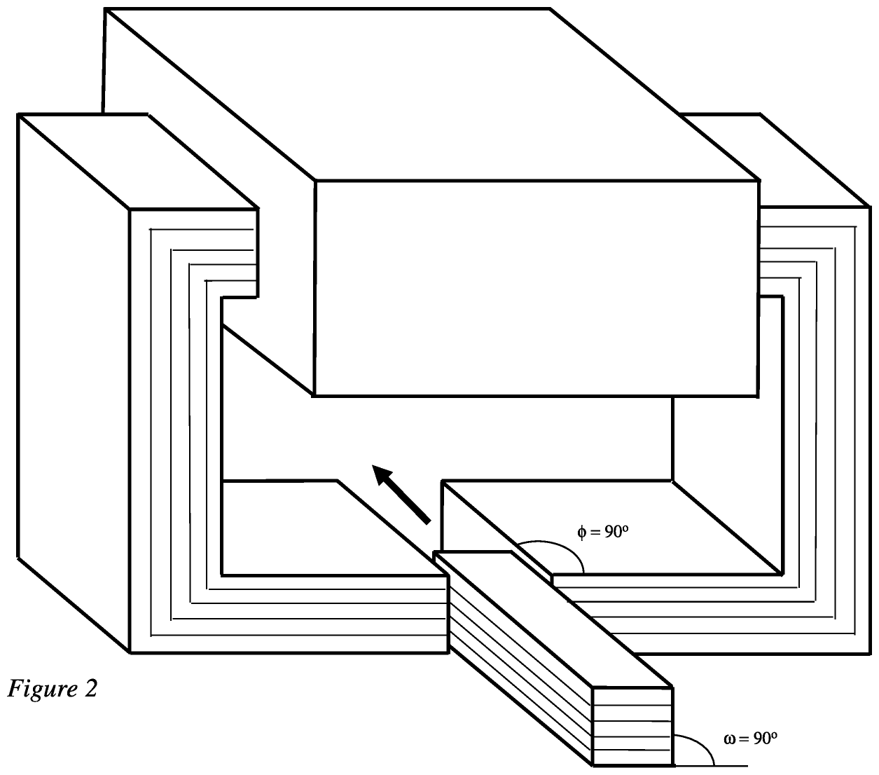

FIG. 2 is identical to FIG. 1, except the linear actuator is also comprised of laminated ferromagnetic material. In this embodiment, the magnetic circuit can only pull the linear actuator into the circuit when it is energized.

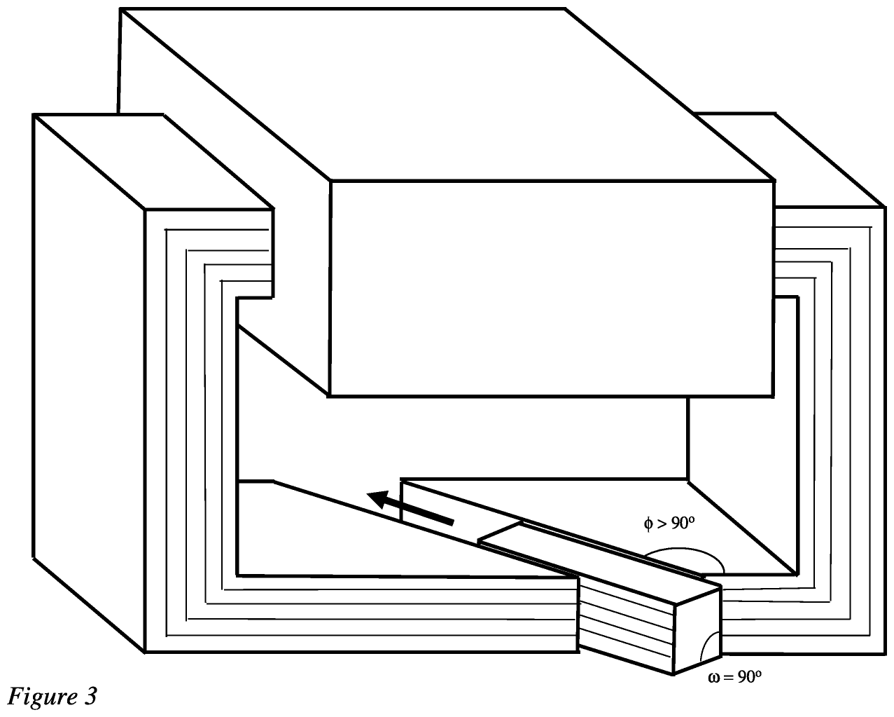

FIG. 3 is identical to FIG. 2, except that the linear actuator is drawn into the magnetic circuit at an increased angle (ϕ>90°). This configuration increases the surface area between the magnetic circuit and the actuator, thereby reducing the reluctance, increasing the magnetic flux, and increasing the force on the actuator.

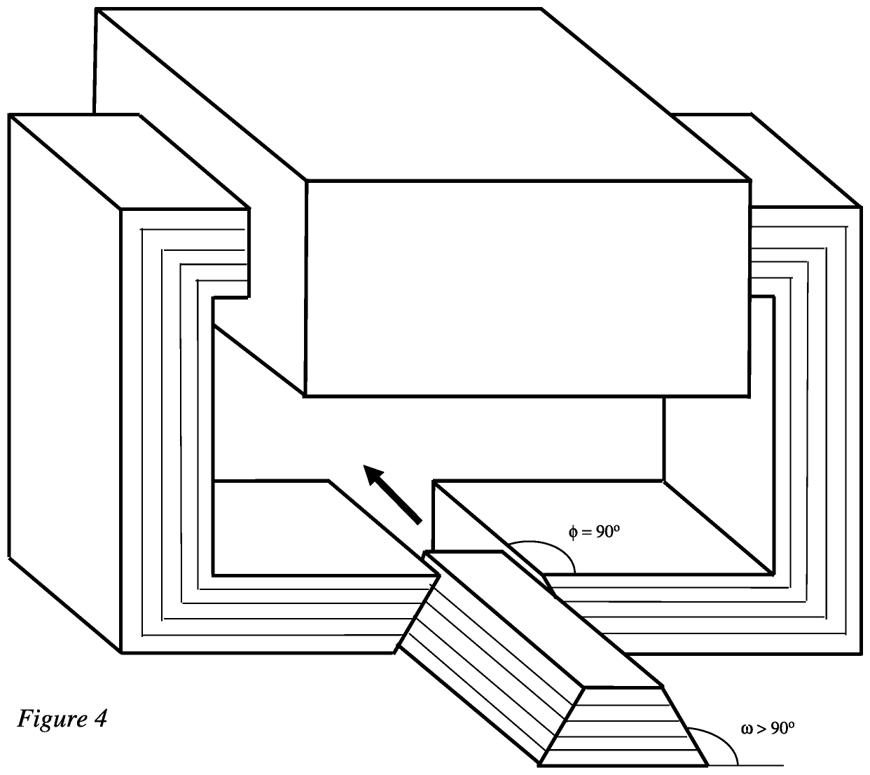

FIG. 4 is identical to FIG. 2, except the side of the actuator is at an increased angle (ω>90°). This configuration increases the surface area between the magnetic circuit and the actuator, thereby reducing the reluctance, increasing the magnetic flux, and increasing the force on the actuator.

FIG. 5 is identical to FIG. 2, except the side of the actuator is “rippled.” This configuration increases the surface area between the magnetic circuit and the actuator, thereby reducing the reluctance, increasing the magnetic flux, and increasing the force on the actuator.

All three methods/configurations shown in FIGS. 3 to 5 may be employed simultaneously.

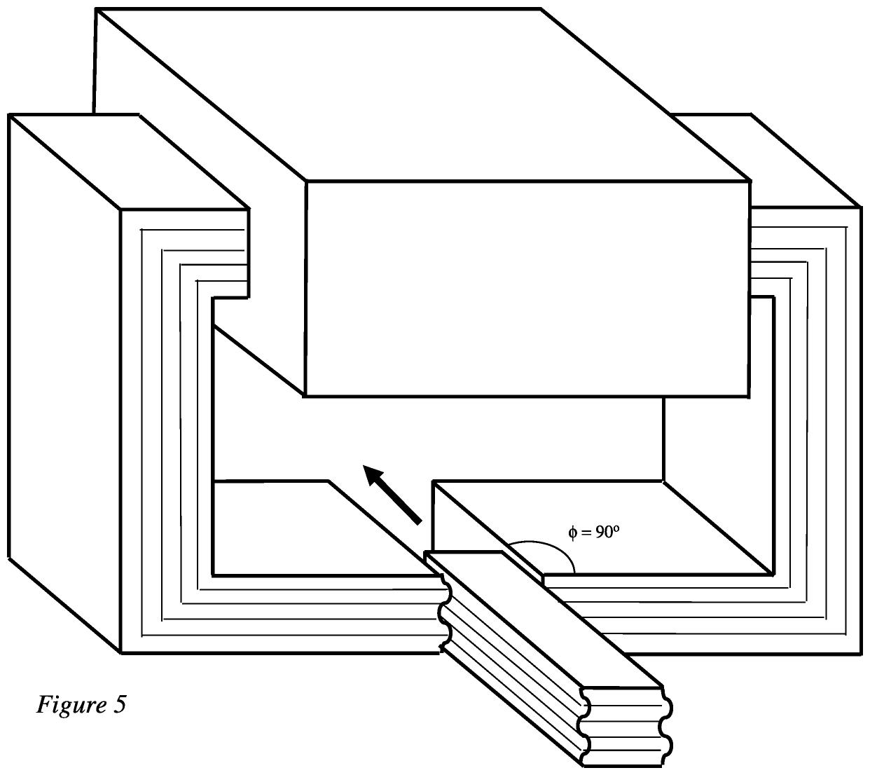

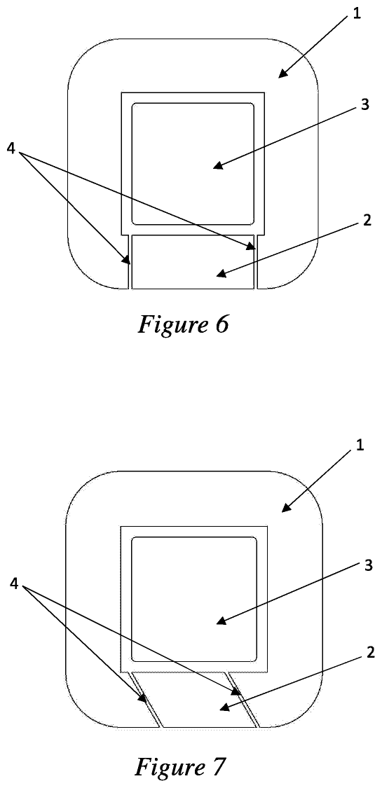

FIG. 6 is a cross-sectional illustration of a single transverse-flux stator (1) and rotor (2) pole magnetic flux loop showing the air gaps (4) that the rotor (2) pole passes through around an axis that is horizontally located in the plane of the page. The transverse-flux coil (3) is located in the center of the magnetic flux loop with the phase current flowing into and out of the page.

FIG. 7 is a cross-sectional illustration of a single transverse-flux stator (1) and rotor (2) pole magnetic flux loop showing the air gaps (4) that are angled in one direction with respect to the magnetic flux path through the stator (1) and rotor (2) poles. The transverse flux coil (3) is located in the center of the magnetic flux loop with the phase current flowing into and out of the page.

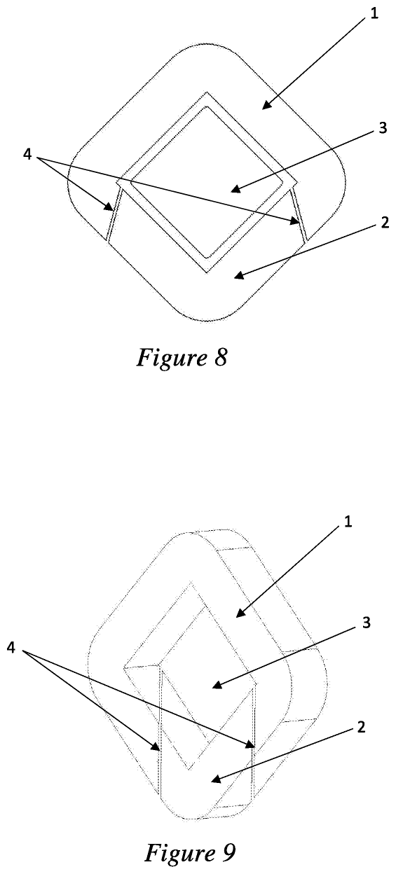

FIG. 8 is a cross-sectional illustration of an alternative embodiment of FIG. 7, wherein the stator and rotor pole are at an angle compared to FIGS. 6 and 7 while the air gaps are also angled with respect to the magnetic flux path.

FIG. 9 is an illustration of an alternative embodiment of FIG. 8, wherein the air gaps (4) are angled in two different directions with respect to the magnetic flux loop of the stator (1) and rotor (2) pole. The transverse-flux coil (3) is not shown in this figure in order to more clearly see the air gaps (4) orientation with respect to the magnetic flux loop.

FIG. 10 is an illustration of another view of the embodiment shown in FIG. 9.

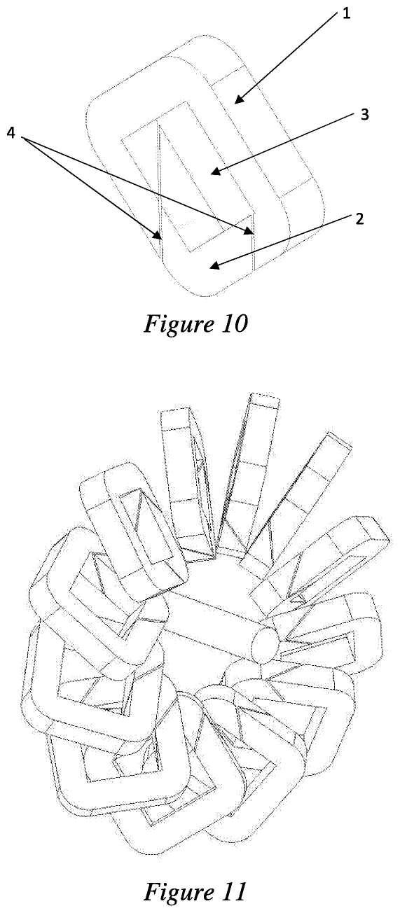

FIG. 11 is a cross-sectional illustration of a radial-flux electrical machine. [Any more details?]

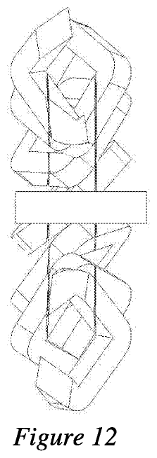

FIG. 12 is an illustration of an axial-flux electrical machine.[Any more details?]

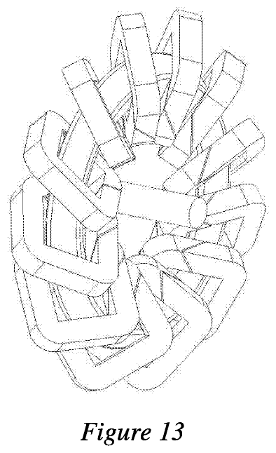

FIG. 13 is an illustration of a transverse-flux electrical machine. [Any more details?]

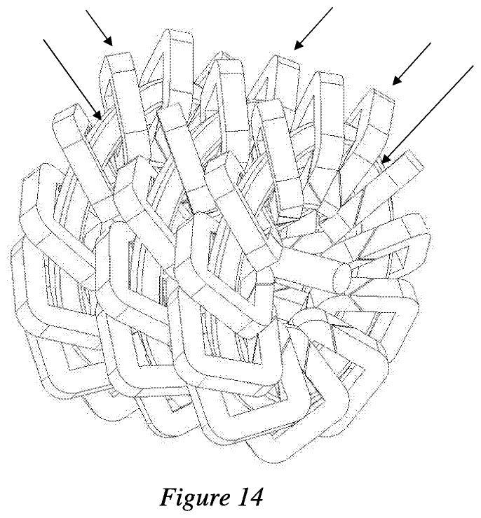

FIG. 14 is an illustration of an electrical machine that improves upon the designs described in U.S. Pat. No. 7,663,283, which is hereby incorporated by reference.

The following are features that may be utilized in some, none, or all of the embodiments of the disclosure
1. An electrical machine wherein the discrete electrically excited electromagnetic poles are arranged in an orientation such that one (or more) electrical phase coil(s) passes through the center of the desired ferromagnetic material loops (circuit) on one side and out the opposite side, thereby inducing a magnetic field in the ferromagnetic material loops (circuit) that circumscribes the cross-section of the electric phase coil(s).
2. The electrical machine as described in Feature 1, wherein the discrete ferromagnetic material loop has one or more air gaps in the loop.
3. The electrical machine described in Feature 1 and 2, wherein one or more sections of the discrete ferromagnetic material loop that is separated by air gaps may be utilized as a moveable component when acted on by the electromagnetic forces of the ferromagnetic material loop.
4. The electrical described in Feature 1, 2 and 3, wherein a foreign component such as a permanent magnet or other ferromagnetic material may be utilized as a moveable component when acted on by the electromagnetic forces of the discrete ferromagnetic material loop.
5. The electrical described in Feature 1, 2, 3 and 4, wherein the discrete ferromagnetic material loops may be arranged in a circular array around the center of one or more electrical phase coils that form a circle, which when the phase coil(s) are electrically energized creates a rotational motion machine commonly referred to as a transverse flux electric motor.
6. The electrical described in Feature 1, 2, 3 and 4, wherein the discrete ferromagnetic material loops may be arranged in a linear array along one or more electrical phase coils, which when the phase coil(s) are electrically energized creates a linear motion machine commonly referred to as a transverse flux linear electric motor or actuator.
7. The electrical machine described in Feature 1, 2, 3, 4, 5 and 6, wherein the air gap(s) of each discrete ferromagnetic material loop are at an angle with respect to the path of the electrical phase coil(s) that pass(es) through the open sides of the discrete ferromagnetic material loop(s).
8. The electrical machine described in Feature 7, wherein an electrical phase coil alternates entering and exiting a progression of discrete ferromagnetic material loops along with other electrical phase coils that when each phase coil is excited electrically in sequence enables motion of the discrete moveable components to create a poly-phase electrical machine.
9. The electrical machine described in Feature 7 and 8, wherein a single-phase coil electrical machine with its plurality of discrete ferromagnetic material loops and moveable components may be combined with one or more additional single-phase coil electrical machine(s) to form a poly-phase array electrical machine.
10. The electrical machine described in Feature 1, 2, 3 and 4, wherein each discrete ferromagnetic material loop may have its own discrete electrical coil which may or may not be electrically connected with other discrete electrical coils to form a singularly activated electrical phase.
11. An electrical machine in which the air gaps between the rotor and stator are angled in one or more directions with respect to the magnetic flux path flowing through the ferromagnetic components.
12. An electrical machine described herein where the rotor poles may be arranged to enable discrete stator/rotor pole sets, each with their own discrete magnetic flux loop, or by orienting the rotors in another direction enabling the complete rotor array to align with the complete stator array forming one continuous magnetic flux loop through all rotors and stators.
13. An electrical machine described herein in which the rotor portions of the ferromagnetic material loops may be made of permanent magnet materials.
14. An electrical machine described herein in which the coils may be comprised of Litz wire to minimize phase coil eddy current losses.
15. An electrical machine described herein in which the transverse flux phase coil(s) is(are) bonded into the stator structure to become a load-bearing member of the stator structure.
16. An electrical machine described herein in which the transverse flux coil(s) is(are) retained using a circumferential coil retainer wedge.
17. An electrical machine described herein in which the circumferential coil retainer wedge may also function as a bearing surface that supports the rotation of the rotor assembly.
18. An electrical machine described herein in which the circumferential coil retainer wedge is made of a ferromagnetic material in order to minimize the magnetic flux leakage from the stator and rotor poles.
19. An electrical machine described herein in which the circumferential coil retainer wedge is made of Thermal Pyrolytic Graphite in order to assist in directing the magnetic flux to remain within the stator and rotor poles.
20. An electrical machine described herein where the rotor carrier is comprised of segments that couple together to form a circular structure.
21. An electrical machine described herein where the stator carrier is comprised of segments that couple together to form a circular structure.
22. An electrical machine described herein where the stator carrier is comprised of two halves that are joined together axially and then joined together by inserting separate keys that lock the two halves together as one piece.
23. An electrical machine described herein where a single electrical machine described herein may be coupled to one or more electrical machines to form a polyphase machine.
24. An electrical machine described herein where a single electrical machine may be coupled to one or more identical electrical machines to sum the torque produced by each utilizing the same electrical phase.
25. An electrical machine described herein where the rotor assembly may be internally located with respect to the stator or externally located with respect to the stator or in front of the stator or behind the stator or a combination thereof.
26. An electrical machine described herein of single-phase construction wherein additional single-phase machines are stacked axially with each other with a slight angular rotation with respect to the adjacent machine in order to minimize torque pulsations from the single-phase assembly.
27. An electrical machine described herein wherein the phase coils of the stator poles are controlled to both attract and/or repel the rotor poles during the full commutation sequence of a complete rotor revolution.
28. An electrical machine described herein wherein Thermal Pyrolytic Graphite is placed between the stator poles facing the transverse coil to reflect the stray magnetic flux leakage flowing between the stator pole and rotor pole.
29. An electrical machine described herein wherein Thermal Pyrolytic Graphite is placed against the phase coil in order to direct the heat generated by the phase coil to a specific location of the stator assembly like a heat pipe device.
30. An electrical machine described herein wherein the rotor poles are comprised of a dual (back-to-back) Halbach Array of permanent magnets that concentrate their flux on each side of the rotor, thereby increasing the torque and efficiency of the electrical machine.
31. An electrical machine described herein in which the ferromagnetic stator poles may be reduced in volume or eliminated altogether enabling the stator coils to function as “air coils” in conjunction with the dual Halbach Array of the rotor to minimize or eliminate the iron eddy current losses.
32. An electrical machine described herein in which the rotor is able to float axially between the air gaps of the stator and rotor in order to minimize loading on the stator structure and reduce structural distortion/vibration.
33. An electrical machine described herein in which polyphase “master” machine may be placed on the front or rear axle(s) of a vehicle and single “slave” phase (or lesser phases than “master”) machine may be placed on the remaining axle(s) to function as a “slave” machine(s) that is(are) inherently or directly controlled by the controllers of the previous polyphase “master” machines.

What is claimed:

1. An electrical machine wherein the discrete electrically excited electromagnetic poles are arranged in an orientation such that one (or more) electrical phase coil(s) passes through the center of the desired ferromagnetic material loops (circuit) on one side and out the opposite side, thereby inducing a magnetic field in the ferromagnetic material loops (circuit) that circumscribes the cross-section of the electric phase coil(s).

2. The electrical machine of claim 1, wherein the discrete ferromagnetic material loop has one or more air gaps in the loop.

3. The electrical machine of claims 1 and 2, wherein one or more sections of the discrete ferromagnetic material loop that is separated by air gaps may be utilized as a moveable component when acted on by the electromagnetic forces of the ferromagnetic material loop.

4. The electrical machine of claims 1, 2 and 3, wherein a foreign component such as a permanent magnet or other ferromagnetic material may be utilized as a moveable component when acted on by the electromagnetic forces of the discrete ferromagnetic material loop.

5. The electrical machine of claims 1, 2, 3 and 4, wherein the discrete ferromagnetic material loops may be arranged in a circular array around the center of one or more electrical phase coils that form a circle, which when the phase coil(s) are electrically energized creates a rotational motion machine commonly referred to as a transverse flux electric motor.

6. The electrical machine of claims 1, 2, 3 and 4, wherein the discrete ferromagnetic material loops may be arranged in a linear array along one or more electrical phase coils, which when the phase coil(s) are electrically energized creates a linear motion machine commonly referred to as a transverse flux linear electric motor or actuator.

7. The electrical machine of claims 1, 2, 3, 4, 5 and 6, wherein the air gap(s) of each discrete ferromagnetic material loop are at an angle with respect to the path of the electrical phase coil(s) that pass(es) through the open sides of the discrete ferromagnetic material loop(s).

8. The electrical machine of claim 7, wherein an electrical phase coil alternates entering and exiting a progression of discrete ferromagnetic material loops along with other electrical phase coils that when each phase coil is excited electrically in sequence enables motion of the discrete moveable components to create a poly-phase electrical machine.

9. The electrical machine of claims 7 and 8, wherein a single-phase coil electrical machine with its plurality of discrete ferromagnetic material loops and moveable components may be combined with one or more additional single-phase coil electrical machine(s) to form a poly-phase array electrical machine.

10. The electrical machine of claims 1, 2, 3 and 4, wherein each discrete ferromagnetic material loop may have its own discrete electrical coil which may or may not be electrically connected with other discrete electrical coils to form a singularly activated electrical phase.

11. An electrical machine in which the air gaps between the rotor and stator are angled in one or more directions with respect to the magnetic flux path flowing through the ferromagnetic components.

12. An electrical machine described herein where the rotor poles may be arranged to enable discrete stator/rotor pole sets, each with their own discrete magnetic flux loop, or by orienting the rotors in another direction enabling the complete rotor array to align with the complete stator array forming one continuous magnetic flux loop through all rotors and stators.

13. An electrical machine described herein in which the rotor portions of the ferromagnetic material loops may be made of permanent magnet materials.

14. An electrical machine described herein in which the coils may be comprised of Litz wire to minimize phase coil eddy current losses.

15. An electrical machine described herein in which the transverse flux phase coil(s) is(are) bonded into the stator structure to become a load-bearing member of the stator structure.

16. An electrical machine described herein in which the transverse flux coil(s) is(are) retained using a circumferential coil retainer wedge.

17. An electrical machine described herein in which the circumferential coil retainer wedge may also function as a bearing surface that supports the rotation of the rotor assembly.

18. An electrical machine described herein in which the circumferential coil retainer wedge is made of a ferromagnetic material in order to minimize the magnetic flux leakage from the stator and rotor poles.

19. An electrical machine described herein in which the circumferential coil retainer wedge is made of Thermal Pyrolytic Graphite in order to assist in directing the magnetic flux to remain within the stator and rotor poles.

20. An electrical machine described herein where the rotor carrier is comprised of segments that couple together to form a circular structure.

21. An electrical machine described herein where the stator carrier is comprised of segments that couple together to form a circular structure.

22. An electrical machine described herein where the stator carrier is comprised of two halves that are joined together axially and then joined together by inserting separate keys that lock the two halves together as one piece.

23. An electrical machine described herein where a single electrical machine described herein may be coupled to one or more electrical machines to form a polyphase machine.

24. An electrical machine described herein where a single electrical machine may be coupled to one or more identical electrical machines to sum the torque produced by each utilizing the same electrical phase.

25. An electrical machine described herein where the rotor assembly may be internally located with respect to the stator or externally located with respect to the stator or in front of the stator or behind the stator or a combination thereof.

26. An electrical machine described herein of single-phase construction wherein additional single-phase machines are stacked axially with each other with a slight angular rotation with respect to the adjacent machine in order to minimize torque pulsations from the single-phase assembly.

27. An electrical machine described herein wherein the phase coils of the stator poles are controlled to both attract and/or repel the rotor poles during the full commutation sequence of a complete rotor revolution.

28. An electrical machine described herein wherein Thermal Pyrolytic Graphite is placed between the stator poles facing the transverse coil to reflect the stray magnetic flux leakage flowing between the stator pole and rotor pole.

29. An electrical machine described herein wherein Thermal Pyrolytic Graphite is placed against the phase coil in order to direct the heat generated by the phase coil to a specific location of the stator assembly like a heat pipe device.

30. An electrical machine described herein wherein the rotor poles are comprised of a dual (back-to-back) Halbach Array of permanent magnets that concentrate their flux on each side of the rotor, thereby increasing the torque and efficiency of the electrical machine.

31. An electrical machine described herein in which the ferromagnetic stator poles may be reduced in volume or eliminated altogether enabling the stator coils to function as “air coils” in conjunction with the dual Halbach Array of the rotor to minimize or eliminate the iron eddy current losses.

32. An electrical machine described herein in which the rotor is able to float axially between the air gaps of the stator and rotor in order to minimize loading on the stator structure and reduce structural distortion/vibration.

33. An electrical machine described herein in which polyphase “master” machine may be placed on the front or rear axle(s) of a vehicle and single “slave” phase (or lesser phases than “master”) machine may be placed on the remaining axle(s) to function as a “slave” machine(s) that is(are) inherently or directly controlled by the controllers of the previous polyphase “master” machines.
